(19) United States
(12) Patent Application Publication
(10) Pub. No.: US 2011/0155077 A1
(43) Pub. Date: Jun. 30, 2011

(54) Disposable rain gear

(76) Inventor: Marni Markell Hurwitz, Far Hills, NJ (US)

(21) Appl. No.: 12/655,288

(22) Filed: Dec. 28, 2009

(51) Int. Cl. A01K 13/00

(52) U.S. Cl. 119/850

(57) ABSTRACT

The invention is directed to disposable rain gear for pets, and method of using same. The disposable rain gear is particularly appointed as a raincoat with/without a hood, and/or a hat/hood. The disposable rain gear generally includes a shell having a water resistant outer layer and being constructed to form a top segment, underside segment with a closure and a front segment with a collar closure. The underside closure and the collar closure each including fastener means. Preferably the fastener means may be comprised of hook and loop fasteners, a tongue and groove fastener mechanism, and/or an adhesive fastener mechanism involving a press and seal configuration. Advantageously, the disposable rain gear for pets provides rain gear that can be readily discarded when it becomes wet and/or soiled after use.

### BACKGROUND OF THE INVENTION

1. Field of the Invention

The present invention relates to disposable rain gear; and more particularly to disposable rain gear, such as coats, hats and hoods, for dogs and household animals, composed of a paper-like material that is eco-friendly, water resistant, durable and lightweight, having a shell with an underside closure and a front collar closure.

2. Description of the Prior Art

Walking pets in the rain or snow can be discomforting. Water accumulation on the pet's back and torso, causes discomfort to the pet, and creates water puddles and mud that may be tracked into the home.

Although various pet clothing articles have been provided, the clothing does not provide rain outerwear that can be readily donned onto the pet and discarded after use to avoid dealing with soiled, smelly articles. The coats and outerwear heretofore disclosed and utilized are not disposable. Consequently, the pet owner is left with a dirty, smelly, wet outfit that must be washed and dried. As the article cannot be discarded, the pet owner or caregiver must bring the soiled article into the home. Once inside the house, the wet animal odors tend to permeate the premises, creating a need for the soiled garment to be hung out to dry. Examples of pet clothing include the following teachings: U.S. Pat. No. 6,058,890 to Harrell discloses a cover including a sheet of flexible absorbent material, and a plurality of fasteners mounted on the sheet for conforming the sheet on a pet to prevent the pet from shaking water from its natural coat; U.S. Pat. No. 3,918,238 to Iozzio discloses a rain jacket for dogs that comprises a forward body portion, a hood portion, two front leg portions and a back flap portion, all mutually attached and comprised of a flexible waterproof material; U.S. Pat. No. 5,060,458 to Curtis discloses a protective coat for dogs and the like, particularly designed for use by hunting and non-hunting dogs to provide safety thru visibility; U.S. Pat. Des No. 379,687 to Curtis discloses a dog blanket; U.S. Pat. No. 5,003,756 to Mazzotta, Sr. discloses a dog coat arranged to cover the chest and a portion of the neck as well as the sides and back having an inner surface provided with flea repelling strips; U.S. Pat. No. 5,463,985 to Shover discloses protective apparel worn by animals; and U.S. Pat. No. 935,166 to Rorabeck discloses an animal cover.

Notwithstanding the efforts of prior art workers to construct animal gear, there is a need in the art for a disposable rain gear for pets and animals. There also exists a need in the art for disposable rain gear, including coats, hats and hoods, for dogs and household animals composed of a paper-like material that is eco-friendly, water and cold resistant, durable and lightweight, and is provided with a shell, and optionally a liner, having an underside closure and a front collar closure that is appointed for disposal after use.

### SUMMARY OF THE INVENTION

The present invention provides disposable rain gear for pets and animals. The disposable rain gear is especially suited for coats, hats and hoods for dogs and household animals. The disposable rain gear, particularly a rain coat, is made of a paper-like material that is eco-friendly, water resistant, durable and lightweight. It may be secured by an adhesive, hook and loop fastener mechanism, or a zip-lock tongue and groove fastener for closure in the front of the coat and the undersides of the coat.

The disposable rain gear for pets includes a shell with a water and cold resistant outer layer. The shell is constructed to form a top segment, underside segment with a closure and a front segment with a collar closure. The underside closure and the collar closure each include fastener means. Preferably the disposable rain gear is constructed as a raincoat. The raincoat may further include a hood portion, which is preferably connected to the disposable raincoat by a perforated line, so that the hood portion may be readily torn from the raincoat. Alternatively, the disposable rain gear is constructed as a poncho with a hood, or may be constructed as a hood/hat portion.

Fastener means of the underside closure and/or collar closure may comprise hook and loop fasteners of the type sold under the trade name VELCRO®. Alternatively, the fastener means of the underside closure and/or collar closure comprises a tongue and groove mating fastener provided as a groove track wherein the tongue slides, much like that utilized for zip-lock type bag constructs used for food storage. In the alternative, the fastener means of the underside closure and/or collar closure comprises adhesive strips. These adhesive strips may include a peel-off strip covering. Preferably, the adhesive strip is constructed as a film strip embossed with pockets containing adhesive so that the adhesive is activated when the film strip is pressed to create a seal. The adhesive is preferably a food based adhesive so that should the animal chew on or otherwise digest any of the adhesive, the adhesive is non-toxic and environmentally friendly. In turn, the shell of the rain gear is preferably composed of a paper or fibrous product, or mixtures thereof. The water resistant outer layer of the shell may include a wax film coating. Alternatively, other materials including polymeric material, nylon, neoprene materials or combinations thereof may be used.

In one embodiment, the rain gear is provided as a raincoat formed as a roll of a plurality of raincoats connected together by perforated lines so that one raincoat at a time may be removed from the roll. The roll is housed in a dispenser so that a user simply pulls out a coat when needed. The raincoat/rain gear is provided in a variety of sizes, shapes, colors and designs, and may have indicia, such as advertising indicia or sports indicia printed thereon. Additionally, the rain gear may include a surface for adding artwork thereon by individual users so that a user can draw images or add words or phrases to the disposable coat, or add glitter or sparkles or the like for their own unique design. For example, a user could write the name of their pet on the raingear. Alternatively, the rain gear is a rain hood and the rain gear is formed as a roll of a plurality of hoods connected together by perforated lines so that one hood at a time may be removed from the roll.

The composition of the rain gear may vary to include a plethora of materials. For example, the rain gear may be composed of a paper or fibrous product, or mixtures thereof, with or without a polymeric, silicon, wax or paraffin coating thereon for repelling water. Alternatively, the rain gear may be composed of a plastic product. Further, the rain gear may be composed of a cloth material and the fastener means may comprise mating hooks and loop fasteners. Or, the rain gear may be composed of a cloth material and the fastener means may comprise mating magnetic strips.

A method of using the disposable rain gear for pets is also provided. The method comprises the steps of: (i) placing the disposable rain gear on a pet, the disposable rain gear comprising a shell having a water resistant outer layer and being constructed to form a top segment, underside segment with a closure and a front segment with a collar closure; (ii) closing the underside closure and the collar closure by way of fastener means; (iii) wearing the disposable rain gear outside in inclement weather; (iv) removing the disposable rain gear from the pet; and (v) discarding the disposable rain gear. Advantageously, the disposable rain gear for pets provides rain gear that can be readily discarded when it becomes wet and/or soiled after use.

### BRIEF DESCRIPTION OF THE DRAWING

The invention will be more fully understood and further advantages will become apparent when reference is had to the following detailed description of the preferred embodiments of the invention and the accompanying drawings, in which:

FIG. 1a illustrates a side view of a first embodiment of the rain gear wherein the rain gear is constructed as a raincoat for a pet, shown in the open condition;

FIG. 1b illustrates a top view of the embodiment of FIG. 1a;

FIG. 2a illustrates a side view of an embodiment of the rain gear wherein the rain gear is constructed as a raincoat for a pet, showing the raincoat worn by a dog;

FIG. 2b illustrates a bottom view of the raincoat and dog of FIG. 2a;

FIG. 3a illustrates a side view of another embodiment of the rain gear wherein the rain gear is constructed as a raincoat for a pet, shown in the open condition;

FIG. 3b illustrates a bottom side view of the embodiment of FIG. 3a in the closed condition;

FIG. 4 illustrates a view of another embodiment of the rain gear wherein the rain gear is constructed as a hood and poncho for a pet, shown in the closed condition as worn on a dog;

FIG. 5 illustrates a view of the rain gear provided as a plurality of coats and/or hoods preferably attached on a roll and housed within a dispenser;

FIG. 6a illustrates a top view of an embodiment of the fastener means wherein the fastener means is formed of embossed pockets containing adhesive;

FIG. 6b illustrates a side view of FIG. 6a; and

FIG. 7 illustrates a view of the tongue and groove embodiment of the fastener means.

### DETAILED DESCRIPTION OF THE INVENTION

The present invention is directed to disposable rain gear for pets, and methods of using same. The disposable rain gear is especially suited for use as a raincoat, and/or a hood. The disposable rain gear generally includes a shell having a water and cold resistant outer layer and being constructed to form a top segment, underside segment with a closure and a front segment with a collar closure. The underside closure and the collar closure each include fastener means. Preferably the fastener means may be comprised of hook and loop fasteners, a tongue and groove fastener mechanism, and/or an adhesive fastener mechanism involving a press and seal configuration. Advantageously, the disposable rain gear for pets provides rain gear that can be readily discarded when it becomes wet and/or soiled after use.

The rain gear, including raincoat and/or hood, is preferably composed of a plethora of materials. For example, the raincoat/rain hood is preferably composed of a thin plastic coated material having insulating properties, or may be composed of a paper or fibrous material having a polymeric, wax or paraffin coating applied thereto to repel or bead water away from the raincoat or rain hood. In one embodiment the raincoat/rain hood is composed of a thin plastic material having an adhesive integrated therein to provide fastener means. The rain gear may be composed of a thin cotton or fibrous material, having a water resistant surface, and being capable of being torn. It may also be provided with a liner to enhance its insulating properties and provide a softer “feel” for the pet.

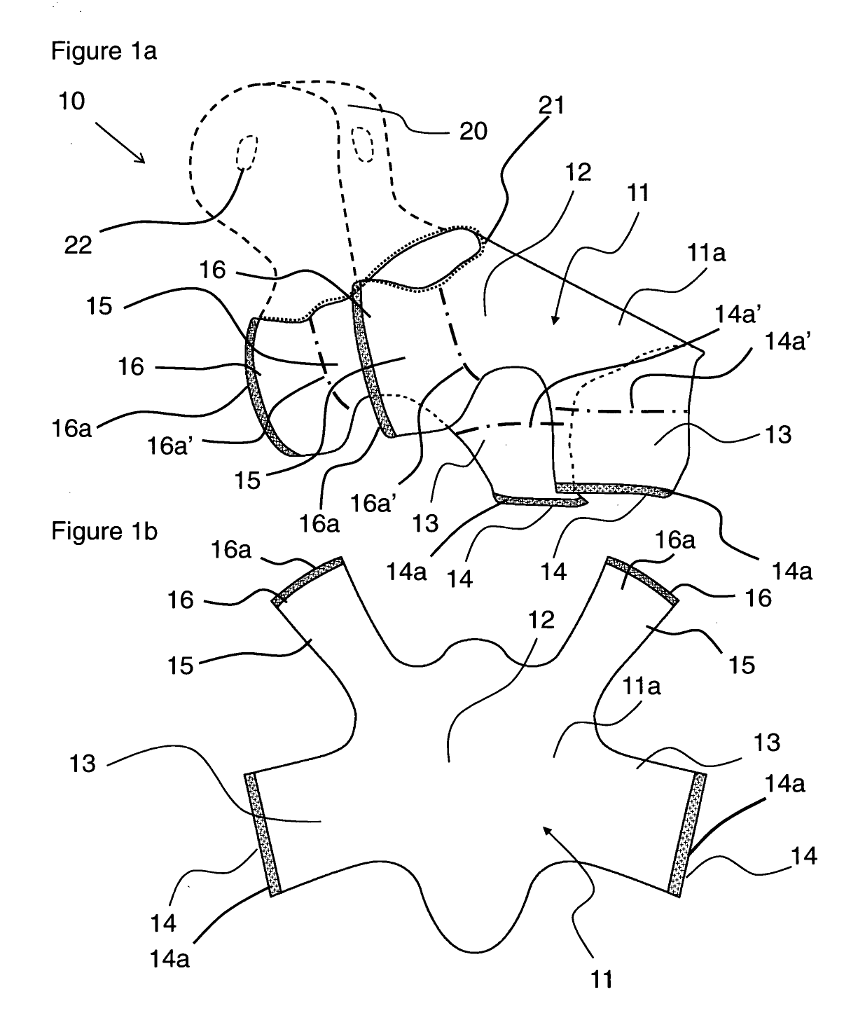

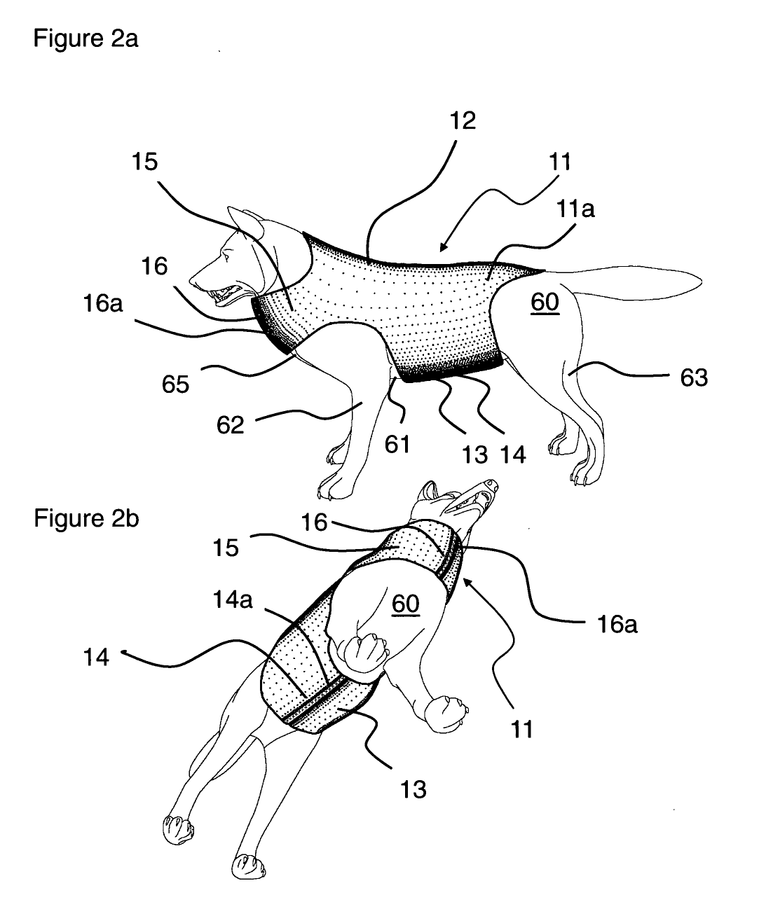

FIG. 1a illustrates a side view of a first embodiment of the rain gear wherein the rain gear is constructed as a raincoat for a pet, shown generally at 10 in the open condition. FIG. 1b illustrates a top view of the embodiment of FIG. 1a. FIG. 2a illustrates a side view of an embodiment of the rain gear wherein the rain gear is constructed as a raincoat for a pet, depicting the raincoat being fitted to the contour of a dog's body; and FIG. 2b illustrates a bottom view of the raincoat and dog of FIG. 2a, wherein the raincoat is in the closed position. Referring to FIGS. 1a, 1b, 2a and 2b, the disposable rain gear for pets is formed as a raincoat 10 including a shell 11 with a water resistant outer layer 11a constructed to form a top segment 12, underside segment 13 with a closure 14 adapted to attach on the underside of rib cage 61 of an animal, such as dog 60, between the front and back leg quarters, 62, 63 as illustrated in FIGS. 2a, 2b. A front segment 15 with a collar closure 16 is also provided. The collar closure 16 is adapted to be attached under the dog's neck in the chest region 65. The underside closure 14 and the collar closure 16 each include two-part fastener means 14a, 16a. The raincoat 10 may further include a hood portion 20 shown in phantom in FIG. 1a, which is preferably connected to the disposable raincoat by perforated line 21 so that the hood portion 20 may be readily torn from the raincoat 10. Ear cut-outs 22 may also be included within hood 20, providing holes for the animal's ears to protrude from. Hood portion 20 may be readily torn from raincoat 10 with a simple pulling action. Shell 11 may be composed of a plurality of layers, or may be a single layer.

When the shell 11 is a single layer, shell 11 is preferably provided as a plastic or polymeric sheet having a thin thickness. When shell 11 is provided as a fibrous or cotton material, the shell 11 preferably includes a polymeric coating or paraffin coating on the outer surface thereof to repel water droplets or provide a waterproof surface.

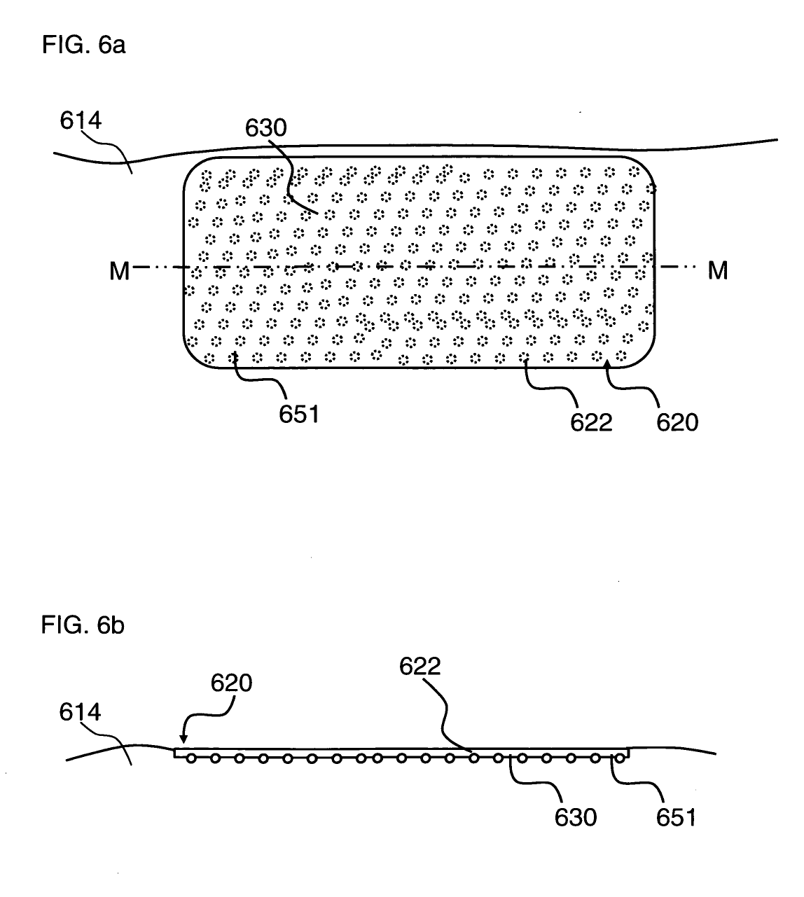

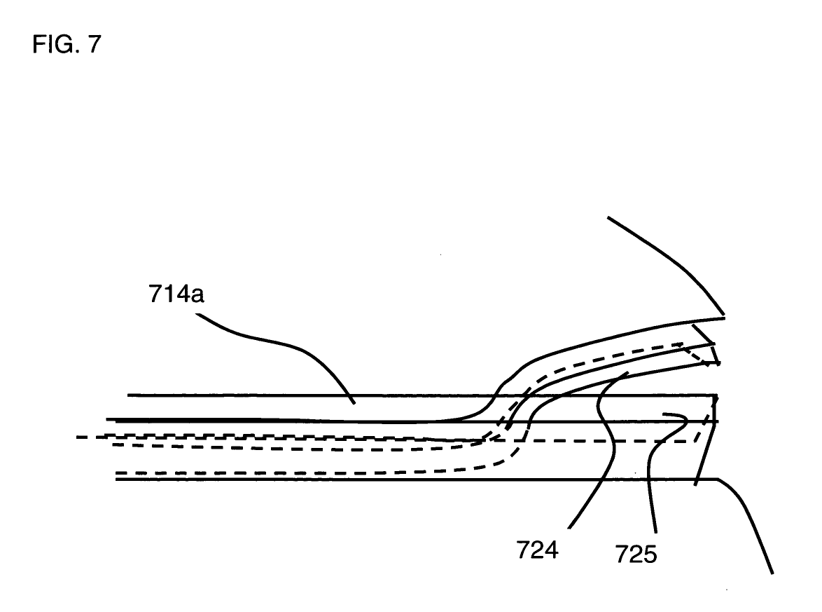

Fastener means 14a, 16a of the underside closure 14 and/or collar closure 16 may comprise hook and loop fasteners, such as are sold under the trade name VELCRO® provided as elongated strips. Alternatively, the fastener means of the underside closure 14a and/or collar closure 16a comprises tongue and groove mating fasteners provided as a groove track wherein the tongue slides within the groove to form a seal, much like that utilized for zip-lock type bag constructs used for food storage (see FIG. 7). In the alternative, the fastener means of the underside closure 14a and/or collar closure 16a comprises adhesive strips. Preferably, each of the closure 14a, 16a includes at least one adhesive portion. These adhesive strips may include a peel-off strip covering that is removed when the adhesive is to be used (not shown). Preferably, the adhesive strip is constructed as a film strip embossed with pockets containing adhesive so that the adhesive is activated when the film strip is pressed to create a seal (see FIG. 6a, 6b). The adhesive is preferably a food based/starch adhesive so that should the animal chew on or otherwise digest any of the adhesive, the adhesive is non-toxic and environmentally friendly. Materials utilized to construct the rain gear may include three-dimensional nesting-resistant sheet materials having a first side and a second side constructed wherein the first side comprises at least one region having a plurality of spaced three-dimensional protrusions extending outwardly from the first side which are preferably unitarily formed from the sheet material. Materials disclosed by U.S. Pat. Nos. 5,965,235 6,193,918; 6,194,062; 6,421,052; 6,489,022; 6,699,347; 6,881,471; 6,818,292; and 6,773,647 provide examples of embossing and adhesive printing processes and apparatuses which have applications in the present invention as potential materials capable of being utilized to form the rain gear herein. To the extent applicable, the teachings of these patents are hereby specifically incorporated in their entireties by reference thereto.

Adhesives utilized preferably include low bond adhesives. The adhesive may be composed of synthetic or natural composition. Natural adhesives may be made from inorganic mineral sources, or biological sources such as vegetable matter, starch (dextrin), natural resins or from animals e.g. casein or animal glue. Starch based adhesives or food based adhesives are preferably used, as they provide a non-toxic adhesive that is also environmentally friendly. Most preferably the adhesive utilized is a pressure sensitive adhesive that forms a bond by the application of light pressure designed for removable applications. Removability of the adhesive allows the adhesive to form a temporary bond so that the rain gear can readily be opened. In forming the rain gear, the adhesive strip/fastener means 14a, 16a is placed on at least a portion of each of the underside closure 14 portions and collar closure 16 portions. As set forth hereinabove, the adhesion may be provided as an embossed film. For example, the disposable rain gear may be made with press 'n seal technology such as that sold under the trade name GRIPTEX®, a gripping technology that is only activated when pressure is applied. Although the technology is utilized in food wrapping, the technology may be utilized to form the rain gear herein. Using the GRIPTEX® fastening means, the raincoat 10 is secured to the animal 200 (FIG. 2a, 2b) by a “press 'n seal” operation. The entire shell 11 may be made of the press 'n seal material, or alternatively each of the collar closures 16 and underside closures 14 may be composed of the press 'n seal material, provided as elongated strips via fastener means 16a, 14a. Although the fastener means 16a, 14a are herein shown as strips on the edge of each of the collar closure 16 and underside closure 14, the fastener means 16a, 14a may extend as wider bands as shown in phantom at 16a′ and 14a′, shown in phantom. In this manner, because the bands 16a′ and 14a′ are wider, the overlap ability of each with its mate is greater, thereby allowing the raincoat 10 to fit thinner animals as the bands 16a′ and 14a′ allow for a smaller circumference within the raincoat 10 (see FIG. 1a). Pattern sizes for the raincoat 10 are typically produced in categories extra small, small, medium, large and extra large.

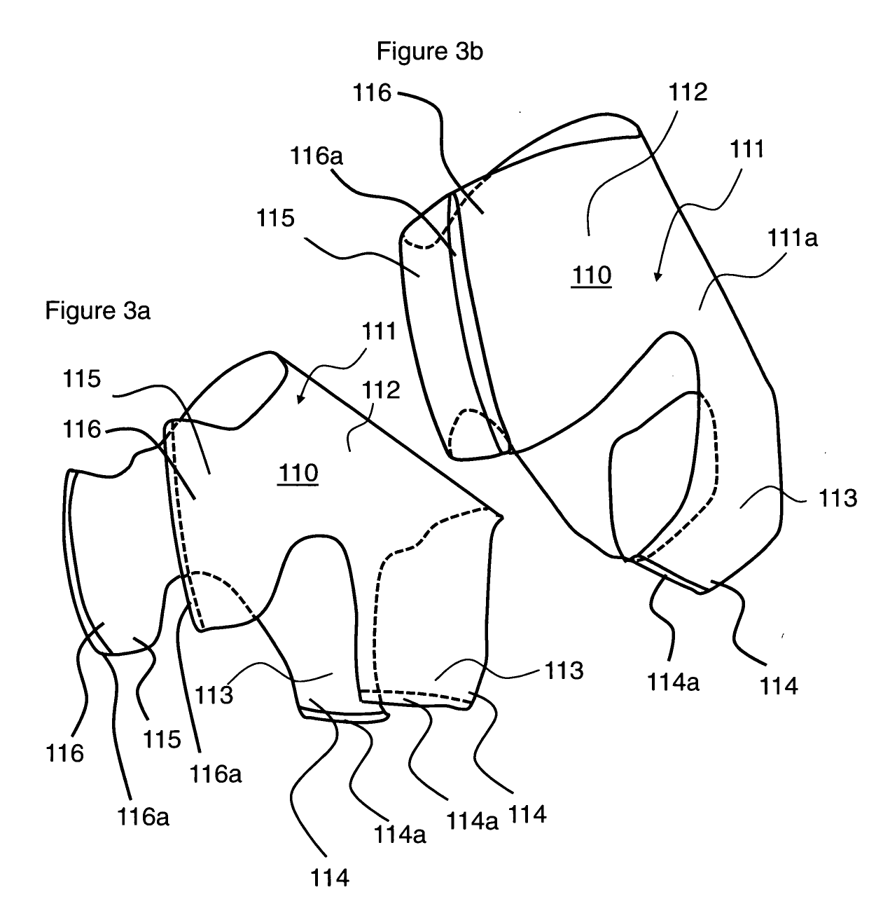

FIG. 3a illustrates a side view of another embodiment of the rain gear. In the embodiment of FIG. 3a, the rain gear, shown in the open condition, is constructed as a raincoat for a pet. FIG. 3b illustrates a bottom side view of the embodiment of FIG. 3a in the closed condition. Raincoat 110 is constructed of a shell 111 with a water resistant outer layer 111a constructed to form a top segment 112, underside segment 113 with a closure 114 and a front segment 115 with a collar closure 116. The underside closure 114 and the collar closure 116 each include fastener means 114a, 116a. Shell 111 may be composed of a plurality of layers, or may be a single layer. When the shell 111 is a single layer, shell 111 is preferably provided as a plastic or polymeric sheet having a decreased thickness. Fastener means 114a, 116a of the underside closure 114 and/or collar closure 116 may comprise hook and loop fasteners, such as are sold under the trade name VELCRO®. Alternatively, the fastener means of the underside closure and/or collar closure can comprise tongue and groove mating fasteners provided as a groove track wherein the tongue slides, much like that utilized for zip-lock type bag constructs used for food storage (see FIG. 7). In the alternative, the fastener means of the underside closure and/or collar closure comprises adhesive strips formed via embossed sheet material which secures closure of the raincoat 110 by pressing fastener means 114a, 116a tightly together. Materials disclosed by U.S. Pat. Nos. 5,965,235 6,193,918; 6,194,062; 6,421,052; 6,489,022; 6,699,347; 6,881,471; 6,818,292; and 6,773,647 provide embossing and adhesive printing processes and apparatuses which have applications in the present invention as potential materials capable of being utilized to form the rain gear herein and/or the fastening portions therein. As set forth hereinabove, the adhesion may be provided as an embossed film. For example, the disposable rain gear may be made with press 'n seal technology such as that sold under the trade name GRIPTEX®, a gripping technology that is only activated when pressure is applied. Although the technology is utilized in food wrapping, the technology may be utilized to form the rain gear herein. Using the GRIPTEX® fastening means, the raincoat is secured to the animal by a “press 'n seal” operation.

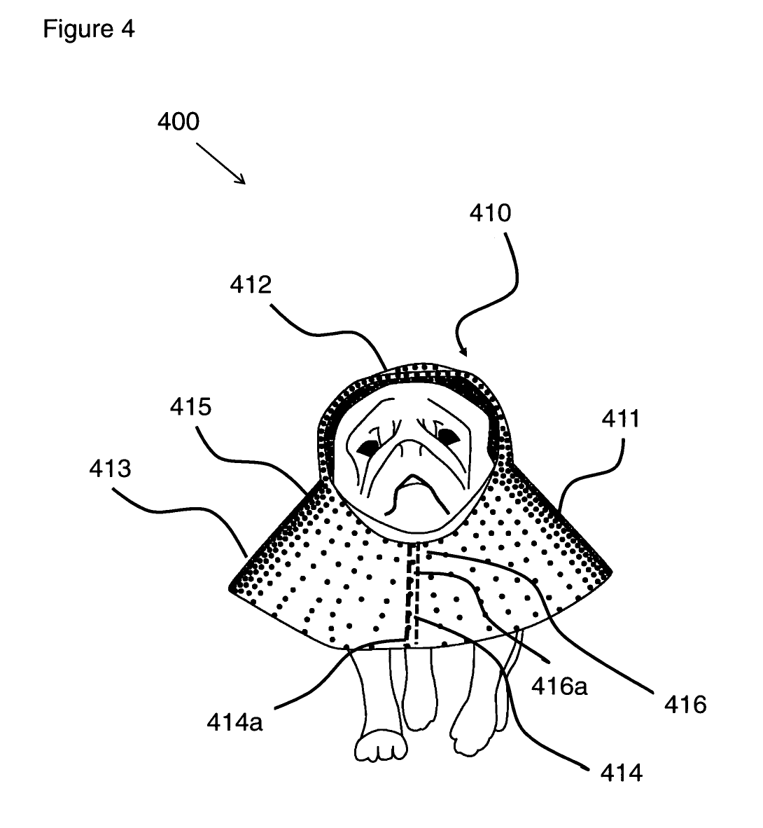

FIG. 4 illustrates a view of another embodiment of the rain gear wherein the rain gear is constructed as a hood and poncho for a pet, shown generally at 400 in the closed condition as worn by a dog. Hood/hood and poncho 410 is constructed of a shell 411 with a water resistant outer layer adapted to form a top segment 412, underside segment 413 with a closure 414 and a front segment 415 with a collar closure 416 which merges with closure 414. The underside closure 414 and the collar closure 416 each include fastener means 414a, 416a. The shell 411 may be composed as herein described concerning the raincoat construction of FIGS. 1-3. Fastener means 414a, 416a may comprise hook and loop fasteners of the type sold under the trade name VELCRO®. Alternatively, the fastener means of the underside closure and/or collar closure can comprise tongue and groove mating fasteners provided as a groove track wherein the tongue slides, much like that utilized for zip-lock type bag constructs used for food storage (see FIG. 7). In the alternative, the fastener means of the underside closure and/or collar closure comprises adhesive strips formed from embossed sheet material which is engagingly secured by pressing fastener means tightly together as set forth hereinabove concerning the structure of the raincoat disclosed with reference to FIGS. 1-3. Alternatively, in this embodiment, the hood and poncho may not have closures and may be simply slid over the dog's head when the hood 410 is placed on the dog.

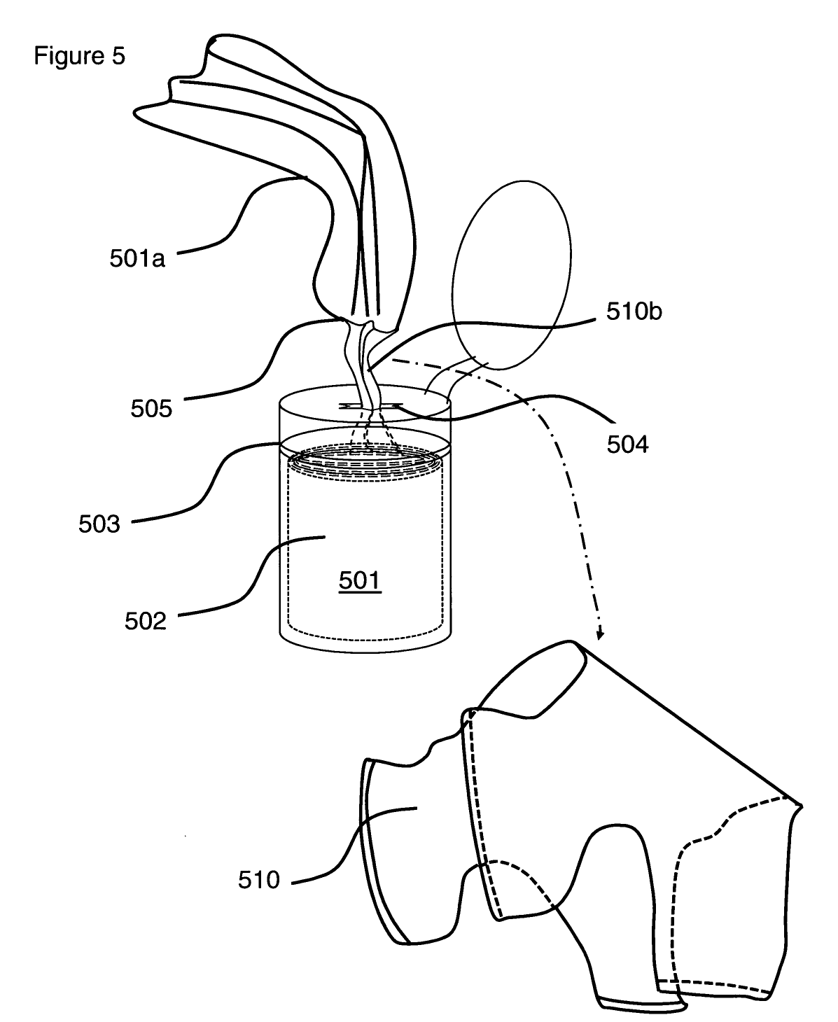

FIG. 5 illustrates a view of the rain gear provided as a plurality of coats and/or hoods preferably attached on a roll and housed within a dispenser. As with the rain coat shown in FIGS. 1a and 1b, the rain gear can be provided with a plurality of reflective materials, such as heat pressed reflective tape, reflective material, reflective threads, reflective decals, temporary tattoos, water resistant markers and paints, glitter, stickers, silk screening reflective paint onto the rain coat material selected, glow-in-the dark applications utilizing phosphorescent markers, and appropriately positioned led's or fiber optics to add additional dimension and safety features to the raincoat.

The raincoat or hood is provided as a continuous sheet with perforations between raincoat portions. A dispenser 501 is provided which includes a vessel 502 and a top 503 with a rain gear feed 504. Rain gear, herein shown as a raincoat 510 is housed on a roll within vessel 502 which feeds the raincoat from the vessel, shown as 501a in its freshly dispensed form and appointed to be torn on perforated line 505, and same is unfolded as shown at 510 and ready for wear. A new raincoat 510b is ready to be pulled from the dispenser 501 when needed. In this manner, as one raincoat 510 is pulled from the dispenser 501; another raincoat 510b protrudes from the device.

FIGS. 6a and 6b illustrate exploded views of an embodiment of the fastener means wherein the sealing means is formed of embossed pockets containing an adhesive. In the most preferred embodiment, the sealing means/fastener means 620 is provided as an adhesive 622 that is capable of press and peel function. That is to say, the collar closure and/or underside closure of the rain gear are pressed together causing the adhesive 622 to activate and seal the rain gear shut and onto the animal. The fastener means or closures (herein closure 614a) are etched or embossed with dimples and the dimples are filled with adhesive, so that upon pressing, the dimples release the adhesive and provide sealing. An adhesive layer 622 comprising at least one pocket (and preferably a plurality of pockets) 630 or a plurality of microcapsules containing adhesive that is readily released when the user applies force or pressure to the adhesive layer, such as by pressing the closures together, respectively, to close same. The adhesive may be released by the application of pressure to the external surface by pressing. This application of pressure causes the pockets or microcapsules to break, releasing the adhesive. The overall volume of the pockets or microcapsules determines the amount of the adhesive available. The closures 614 are formed by embossing a polymeric or fibrous sheet to create the packets and same is filled with the adhesive. The shape of the pockets may be spherical, cylindrical or elongated or any suitable shape. A second polymeric strip 651, which is substantially thinner than that of the closures 614, is bonded on top of the embossed adhesive filled pockets thereby encapsulating the adhesive therein. The application of pressure effectively breaks the pockets thereby releasing the adhesive. The spreadability of the adhesive is determined by its volume, viscosity and its surface tension. Since pockets contain larger volume of the adhesive, they can be spaced apart further based on the volume. The volume is generally in the range of 0.01 cc to 0.5 cc and the spacing between the pockets is in the range of 0.01 cm to 0.2 cm. Microcapsules are generally small and contain only a small quantity of scent and can only spread over a small distance approximating a few times the diameter of the microcapsule. These microcapsules may be added to the adhesive and are nearly uniformly dispersed in the adhesive layer.

FIG. 7 illustrates a view of the tongue and groove embodiment of the fastener means. In this embodiment, the closure (herein closure 714a) is formed having a tongue 724 which is received within a groove 725. The tongue and groove type closure may be similar to that used for zip and seal sandwich bags.

Key features of the disposable rain gear for pets include:
1. disposable rain gear for pets constructed as a raincoat and/or a hood with poncho assembly;
2. the rain gear is designed so that it is utilized for a single use and is appointed to be discarded, thereby alleviating the need to wash or clean the soiled rain wear, and avoiding the need to bring the wet outer wear inside the home;
3. the rain gear is constructed from a lightweight, durable material having water resistant or repellant properties;
4. the rain gear may utilize plastic materials with embossed pockets;
5. the rain gear may utilize fastener means including hook and loop fasteners, adhesive fastening mechanisms, and/or tongue and groove fastener mechanisms.
   The rain gear and method of use disclosed herein can be modified in numerous ways without departing from the scope of the invention. For example, different rain gear material and/or fastening means may be used. These and other modifications are intended to fall within the scope of the invention, as defined by the subjoined claims.

Having thus described the invention in rather full detail, it will be understood that such detail need not be strictly adhered to, but that additional changes and modifications may suggest themselves to one skilled in the art, all falling within the scope of the invention as defined by the subjoined claims.

What is claimed is:

1. Disposable rain gear for pets, comprising:
a. a shell having a water resistant outer layer and being constructed to form a top segment, underside segment with a closure and a front segment with a collar closure;
b. said underside closure and said collar closure each including fastener means.

2. Disposable rain gear as recited by claim 1, wherein said rain gear is constructed as a raincoat.

3. Disposable rain gear as recited by claim 2, wherein said raincoat includes a hood portion.

4. Disposable rain gear as recited by claim 3, wherein said hood portion is connected to said disposable raincoat by a perforated line, so that said hood portion may be readily torn from said raincoat.

5. Disposable rain gear as recited by claim 1, wherein said rain gear is constructed as a poncho with hood.

6. Disposable rain gear as recited by claim 1, wherein said rain gear is constructed as a hood.

7. Disposable rain gear as recited by claim 1, wherein said fastener means of said underside closure comprises hook and loop fasteners.

8. Disposable rain gear as recited by claim 1, wherein said fastener means of said underside closure comprises tongue and groove mating fasteners.

9. Disposable rain gear as recited by claim 1, wherein said fastener means of said collar closure comprises hook and loop fasteners.

10. Disposable rain gear as recited by claim 1, wherein said fastener means of said collar closure comprises tongue and groove mating fasteners.

11. Disposable rain gear as recited by claim 1, wherein said fastener means of said underside closure and said collar closure comprises adhesive strips.

12. Disposable rain gear as recited by claim 11, wherein said adhesive strips comprise peel-off strip coverings.

13. Disposable rain gear as recited by claim 11, wherein said adhesive strip is constructed as a film strip embossed with pockets containing adhesive so that said adhesive is activated when said film strip is pressed to create seal.

14. Disposable rain gear as recited by claim 1, wherein said shell is composed of a paper or fibrous product, or mixtures thereof.

15. Disposable rain gear as recited by claim 1, wherein said water resistant outer layer of said shell is composed of a wax film coating.

16. Disposable rain gear as recited by claim 1, wherein said rain gear is a raincoat and said rain gear is formed as a roll of a plurality of raincoats connected together by perforated lines so that one raincoat at a time may be removed from said roll.

17. Disposable rain gear as recited by claim 16, wherein said roll is housed within a dispenser.

18. Disposable rain gear as recited by claim 1, wherein said rain gear includes a variety of sizes, including extra small, small, medium, large and extra large.

19. Disposable rain gear as recited by claim 1, wherein said rain gear includes a variety of colors and patterns and indicia printed thereon.

20. Disposable rain gear as recited by claim 1, wherein said rain gear includes a surface for adding artwork thereon such as heat pressed reflective tape, reflective material, reflective threads, reflective decals, temporary tattoos, water resistant markers and paints, glitter, stickers, silk screening reflective paint, glow-in-the dark applications utilizing phosphorescent paint or markers, and led's or fiber optics.

21. Disposable rain gear as recited by claim 1, wherein said rain gear is a rain hood and said rain gear is formed as a roll of a plurality of hoods connected together by perforated lines, so that one hood at a time may be removed from said roll.

22. A method of using disposable rain gear for pets, comprising the steps of:
a. placing said disposable rain gear on a pet, said disposable rain gear comprising a shell having a water resistant outer layer and being constructed to form a top segment, underside segment with a closure and a front segment with a collar closure;
b. closing said underside closure and said collar closure by way of fastener means;
c. wearing said disposable rain gear outside in inclement weather;
d. removing said disposable rain gear from said pet;
e. discarding said disposable rain gear.
